(19) United States
(12) Patent Application Publication
(10) Pub. No.: US 2023/0191754 A1
(43) Pub. Date: Jun. 22, 2023

(54) GLAZING UNIT HAVING AN AUDIO EXCITER

(71) Applicant: SAINT-GOBAIN GLASS FRANCE, COURBEVOIE (FR)

(72) Inventor: Jean-Philippe BOURE, RIBECOURT-DRESLINCOURT (FR)

(21) Appl. No.: 17/924,851

(22) PCT Filed: May 11, 2021
(86) PCT No.: PCT/FR2021/050820

§ 371 Date: Nov. 11, 2022

(30) Foreign Application Priority Data
May 13, 2020 (FR) FR2004696

(51) Int. Cl. B32B 17/10; B32B 3/08; B32B 3/26; B32B 27/30; H04R 1/02

(52) U.S. Cl. CPC B32B 17/10788; B32B 3/08; B32B 3/266; B32B 17/10036; B32B 27/306; B32B 27/30; H04R 1/025; H04R 1/028; B32B 2250/40; B32B 2551/00; B32B 2605/00; H04R 2499/13

(57) ABSTRACT

A glazing includes a glass sheet or a glazed assembly including at least one hole; and at least one audio exciter mounted on a mounting, wherein the mounting is inserted into the at least one hole of the glass sheet or of the glazed assembly.

### FIELD OF THE INVENTION

The present invention relates to a glazing comprising at least one audio exciter.

### TECHNICAL BACKGROUND

Audio or surface exciters make it possible to generate sound from any given wall (plaster, glass, wood, etc.) for mainly audio functions but also for specific applications such as active control of noise or vibrations. The sound generation is caused by the vibrations of the structure to which the exciter is secured via a rigid connection.

For example, document WO 2013/164540 discloses a glazing comprising a piezoelectric transducer formed by a piezoelectric element located between two electrodes, for diverse applications such as: to clean the dust present on the glazing, as a speaker, as a microphone, as an electricity generator or to deaden or amplify sounds coming from outside or inside a building.

Specifically in the automotive industry, new audio functionalities are being developed. In addition to traditional entertainment, advanced entertainment, active noise control, personal voice assistant, engine sound design are new functionalities made possible today by technological developments in transducers, controllers and signal processing. To perform these functions, modern cars are equipped with an increasing number of sensors and audio surface exciters.

Compared to conventional speakers, audio exciters can be lighter. Due to their compact size, they can be integrated into the door panels, the various trims (such as roof or pillar trims), and thus be positioned in the passenger compartment as close as possible to the ears of the passengers. They can be used in addition to or instead of standard loudspeakers.

However, the integration of such equipment is subject to a specific constraint in the automotive field: it must comply with the standards (such as ECE R21 and ECE R26 standards) and specifications of car manufacturers for the safety of the passengers in the motor vehicle's passenger compartment.

There is a need to develop an audio system that can be lighter and with good sound performance.

### SUMMARY OF THE INVENTION

The invention relates firstly to a glazing comprising:
a glass sheet or a glazed assembly comprising at least one hole, the glazed assembly being a multilayer glazed element of which at least one layer is a glass sheet, and
at least one audio exciter mounted on a mounting;
wherein the mounting is inserted into the at least one hole of the glass sheet or of the glazed assembly.

In certain embodiments, the glass sheet is made of organic or mineral glass or the glazed assembly comprises at least one glass sheet which is made of organic or mineral glass and which preferably comprises the hole.

In certain embodiments, the glazed assembly comprises at least one glass sheet, the glass sheet comprising the hole.

In certain embodiments, the glazing comprises a glazed assembly and the glazed assembly is a laminated glazing comprising at least one first glass sheet and a second glass sheet between which at least one interlayer film made of viscoelastic plastic material is inserted, the interlayer film made of viscoelastic plastic material preferably being made of polyvinyl butyral (PVB) or of ethylene vinyl acetate copolymer, more preferably of PVB, in particular of standard PVB, and more preferably of acoustic PVB.

In certain embodiments, the at least one hole is only present in the first glass sheet or only present in the first glass sheet and in the at least one interlayer film made of viscoelastic plastic material.

In certain embodiments, the at least one hole is a blind hole.

In certain embodiments, the mounting comprises a lower face and the at least one hole comprises a lower inner surface, the lower face of the mounting bearing against the lower inner surface of the at least one hole.

In certain embodiments, the at least one hole is a through-hole.

In certain embodiments, the at least one hole and the mounting inserted into the at least one hole have a substantially identical cross section.

In certain embodiments, the mounting comprises a lower part and an upper part, the upper part projecting with respect to the lower part.

In certain embodiments, the upper part of the mounting has a lower face, said lower face partially covering the glass sheet or the glazed assembly.

In certain embodiments, the mounting is secured in the at least one hole by means of adhesive and/or by clamping of the mounting in the at least one hole.

In certain embodiments, the mounting comprises an attachment part, the audio exciter being secured to said attachment part.

In certain embodiments, the glazing is a vehicle glazing, preferably of a motor vehicle.

In certain embodiments, the glazing is a construction glazing, such as a glazing of a window or a building facade.

The invention likewise relates to a method for manufacturing a glazing as disclosed herein before, comprising the following steps:
providing a glass sheet or a glazed assembly and at least one audio exciter mounted on a mounting;
boring at least one hole in the glass sheet or the glazed assembly; and
inserting the mounting into the at least one hole of the glass sheet or of the glazed assembly.

The invention likewise relates to a method for manufacturing a glazing as disclosed herein before, comprising the following steps:
providing a glass sheet or a glazed assembly, at least one audio exciter and at least one mounting;
boring at least one hole in the glass sheet or the glazed assembly;
inserting the at least one mounting into the at least one hole of the glass sheet or of the glazed assembly; and
mounting the at least one audio exciter on the at least one mounting.

The present invention makes it possible to meet the need expressed herein before. It more particularly provides a glazing with a light and compact audio system that offers good sound performance. Additionally, the glazing according to the invention is suitable for use in a vehicle, making it possible to respect the safety of the passengers of the vehicle in which it is placed, as well as in a building.

This is accomplished by virtue of the specific assembly of an audio exciter and a glass sheet or a glazed assembly by means of a hole present in the glass sheet or the glazed assembly. The use of a glazing as an audio system generally makes it possible to offer the audio exciter a large surface capable of vibrating in order to produce a sound, as is usually the case in automotive glazings or glazed windows or facades of buildings. This thus enables optimal sound performance.

In the particular embodiments wherein the glazing according to the invention is a vehicle glazing, the glazing is typically located near the ears of the passengers of the vehicle, which enables a better auditory experience for the passengers. Additionally, the assembly of the audio exciter on the glass sheet or the glazed assembly according to the invention can make it possible to meet the constraints imposed by standards concerning the safety of the passengers of the vehicle.

### BRIEF DESCRIPTION OF THE FIGURES

FIG. 1 depicts a schematic cross sectional view of an example of glazing according to the invention.

FIG. 2 depicts a schematic cross sectional view of another example of glazing according to the invention.

FIG. 3 depicts a schematic cross sectional view of another example of glazing according to the invention.

FIG. 4 depicts a schematic cross sectional view of another example of glazing according to the invention.

FIG. 5 depicts a schematic cross sectional view of another example of glazing according to the invention.

FIG. 6 depicts a schematic cross sectional view of another example of glazing according to the invention.

FIG. 7 depicts a schematic cross sectional view of another example of glazing according to the invention.

FIG. 8 depicts a schematic cross sectional view of another example of glazing according to the invention.

FIG. 9 depicts a schematic cross sectional view of another example of glazing according to the invention.

FIG. 10 depicts a schematic cross sectional view of another example of glazing according to the invention.

FIG. 11 depicts a schematic cross sectional view of another example of glazing according to the invention.

FIG. 12 depicts a schematic cross sectional view of a mounting that can be used in glazing according to the invention, before being inserted into the hole of the glass sheet or of the glazed assembly of the glazing.

FIG. 13 depicts a schematic cross sectional view of the mounting depicted in FIG. 12, once inserted into the hole of the glass sheet or of the glazed assembly of the glazing.

FIG. 14 depicts the acoustic responses of the glazing 1 (gray curve) and of the glazing 2 (black curve) as disclosed in example 1. The frequency, in Hz, is shown on the X-axis and the sound pressure level, in dB, is shown on the Y-axis.

### DETAILED DESCRIPTION

The invention is disclosed below in greater detail and in a non-limiting manner in the following disclosure.

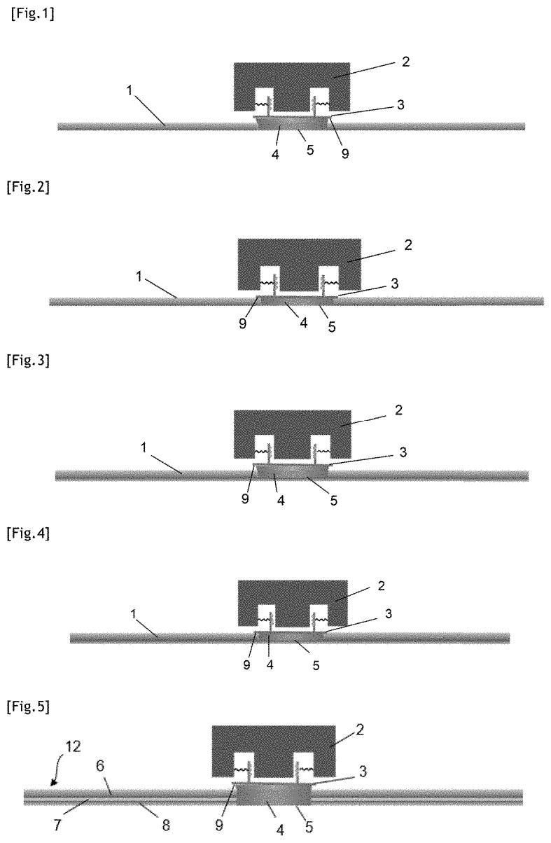

In the present text, the glazing according to the invention is disclosed considering it to be oriented in a horizontal direction, as depicted in FIGS. 1 to 11: the terms “lower” or “upper” are thus used in reference to this configuration. However, the glazing according to the invention can obviously have any possible orientation (for example, a vertical orientation).

### Glazing

The invention relates to a glazing comprising at least one audio exciter.

According to the present invention, “glazing” denotes any structure comprising at least one glass sheet or a glazed assembly. Thus, the glazing can for example comprise a single glass sheet or a glazed assembly made up of laminated glazing consisting of at least two glass sheets between which an interlayer made of viscoelastic plastic material is disposed. “Glazed assembly” is understood to mean a multilayer glazed element of which at least one layer is a glass sheet.

The glass sheet or the glazed assembly can be transparent or opaque, for example, when the glass sheet or the glazed assembly is covered with an opaque coating. The opaque coating can be a paint or an enamel, for example, black-colored. The glass sheet or the glazed assembly can comprise a transparent glazed part and an opaque glazed part, for example, the opaque glazed part can surround the transparent glazed part. Alternatively, the glass sheet, or the glazed assembly, can be tinted in its thickness over all or part of its surface.

The glass sheet is made of organic or mineral glass. It can be made of tempered glass.

Advantageously, the glazing according to the invention comprises a glazed assembly. The glazed assembly comprises at least one glass sheet. The glass can be organic or mineral glass. The glass can be tempered. The glazed assembly is preferably laminated glazing. “Laminated glazing” is understood to mean at least two glass sheets (referred to in the present text as first glass sheet (or also upper glass sheet) and second glass sheet (or also lower glass sheet), respectively) between which at least one interlayer film generally made of viscoelastic plastic material is inserted. The use of laminated glazing, with respect to a single glass sheet, leads to a flatter response due to the dampening provided by the interlayer film, which improves the response of the audio system, in particular as regards the low frequencies. The interlayer film made of viscoelastic plastic material can comprise one or more layers of a viscoelastic polymer such as polyvinyl butyral (PVB) or an ethylene vinyl acetate copolymer (EVA), more preferably PVB. The interlayer film is preferably made of standard PVB or, even more preferably, of acoustic PVB (such as single-layer or tri-layer acoustic PVB). Acoustic PVB generally consists of three layers: two outer layers of standard PVB and an inner layer of PVB with added plasticizer so as to make it less rigid than the outer layers. The use, in laminated glazing, of an acoustic PVB, with respect to a standard PVB, makes it possible to further improve the low frequency restitution and to reduce vibration problems.

The glazing according to the invention can have any possible shape. In certain embodiments, the glazing has a quadrilateral shape, in particular rectangular or substantially rectangular, or trapezoidal or substantially trapezoidal. In other embodiments, the glazing is circular, or substantially circular, or elliptical, or substantially elliptical. The edges of the glazing can be straight or substantially straight (they can have a slight curve) and/or curved. In particular, the glass sheet or the glazed assembly of the glazing can have the shapes mentioned herein before.

The glass sheet or the glazed assembly comprises two main surfaces opposite one another corresponding to the surfaces of the glass sheet or of the glazed assembly having the largest surface areas.

Conveniently, the glass sheet or the glazed assembly has a thickness (between its two main surfaces) greater than or equal to 1.6 mm (and in some embodiments up to several tens of millimeters), for example a thickness of 1.6 to 24 mm, such as a thickness of 1.6 to 6 mm, or 6 to 10 mm, or 10 to 24 mm.

The glass sheet or the glazed assembly of the glazing according to the invention comprises at least one hole. Preferably, the glazed assembly comprises at least one glass sheet, particularly a glass sheet made of organic or mineral glass, the glass sheet comprising the hole.

The hole can have any appropriate shape. The hole can have a cross section (corresponding to the section of the hole in a plane parallel to the main plane of the glass sheet or of the glazed assembly) that is circular or substantially circular. Alternatively, the hole can have a cross section that is rectangular or substantially rectangular. Preferably, the hole is prism-shaped or cylindrical.

The cross section of the hole can have a diameter of 5 to 50 mm, for example, of 10 to 20 mm. Alternatively, the cross section of the hole can have a length of 9 to 50 mm, for example, of 20 to 30 mm, and/or a width of 5 to 50 mm, for example, of 5 to 15 mm.

The hole can be a through-hole, that is, extending through the entire thickness of the glass sheet or of the glazed assembly.

Alternatively, the hole can be blind. In these embodiments, the hole is present on a main surface of the glass sheet or of the glazed assembly but does not open onto the opposite main surface of the glass sheet or of the glazed assembly. The hole then has a thickness (or depth) that is less than the thickness of the glass sheet or of the glazed assembly. The hole comprises a lower inner surface (or bottom) (corresponding to the inner surface of the hole furthest from the opening of the hole in the surface of the glass sheet or of the glazed assembly) and one or more side inner surfaces (corresponding to the one or more inner surfaces of the hole connecting its lower inner surface to its opening in the surface of the glass sheet or of the glazed assembly).

The thickness of the blind hole (from its lower inner surface to its opening in the surface of the glass sheet or of the glazed assembly) is advantageously equal to 20 to 90% of the thickness of the glass sheet or of the glazed assembly, preferably equal to 30 to 80% of the thickness of the glass sheet or of the glazed assembly. In certain embodiments, the thickness of the hole can be equal to 5 to 10%, or 10 to 20%, 20 to 30%, or 30 to 40%, or 40 to 50%, or 50 to 60%, or 60 to 70, or 70 to 80%, or 80 to 90%, or 90 to 95% of that of the glass sheet or of the glazed assembly.

When the glazing comprises a glazed assembly which is a laminated glazing, the blind hole can in particular be present in the first glass sheet, more particularly be only present in the first glass sheet, even more particularly be only present in the first glass sheet and pass through the entire thickness of the first glass sheet. In the latter case, the lower inner surface of the hole coincides with the upper surface of the interlayer film. Alternatively, the hole can be present in the first glass sheet and in the at least one interlayer film, more particularly be only present in the first glass sheet and in the at least one interlayer film, even more particularly be only present in the first glass sheet and in the at least one interlayer film and pass through the entire thickness of the first glass sheet and the interlayer film. In the latter case, the lower inner surface of the hole coincides with the upper surface of the second glass sheet.

In certain embodiments, the glass sheet or the glazed assembly can comprise at least two holes, or at least 3, or at least 4, or at least 5, or at least 10, or at least 15 holes, for example, 1 to 2, or 2 to 3, or 3 to 4, or 4 to 5, or 5 to 5 to 6, or 6 to 7, or 7 to 8, or 8 to 9, or 9 to 10, or 10 to 12, or 12 to 15, or 15 to 20 holes. When the glass sheet or the glazed assembly comprises several holes, the characteristics disclosed herein before can be applied to at least one of the holes, to each hole independently, or to all the holes.

The glazing according to the invention comprises at least one audio exciter. In this regard, it forms an audio system, that is, a system capable of emitting sounds. The audio exciter is mounted on a mounting inserted into a hole of the glass sheet or of the glazed assembly. In certain embodiments, the glazing can comprise a single audio exciter, or at least two audio exciters, or at least 3, or at least 4, or at least 5, or at least 10, or at least 15 audio exciters, for example, 1 to 2, or 2 to 3, or 3 to 4, or 4 to 5, or 5 to 5 to 6, or 6 to 7, or 7 to 8, or 8 to 9, or 9 to 10, or 10 to 12, or 12 to 15, or 15 to 20 audio exciters. In a particularly preferred way, the glazing comprises an identical number of audio exciters and holes in the glass sheet or the glazed assembly, the mounting of each audio exciter being inserted into a hole of the glass sheet or of the glazed assembly. When the glazing comprises several audio exciters, the characteristics disclosed hereunder can be applied to at least one of the audio exciters, to each audio exciter independently, or to all the audio exciters.

The audio exciter (or actuator, or transducer) according to the invention can be any exciter transforming an electric current into mechanical energy making it possible to vibrate a surface, used as a diaphragm, to create a sound wave. In the context of the present invention, the surface vibrated by the exciter comprises or is the glass sheet or the glazed assembly.

The audio exciter can be a piezoelectric audio exciter or an electrodynamic audio exciter (or an inertial exciter). In a particular preferred way, the audio exciter is an electrodynamic exciter. Indeed, piezoelectric exciters require a very high voltage and generally include expensive, heavy electronic components.

Advantageously, the audio exciter has a weight of less than 300 g, preferably a weight of 100 to 200 g. The audio exciter can have a weight of 30 to 50 g, or of 50 to 80 g, or of 80 to 100 g, or of 100 to 120 g, or of 120 to 150 g, or of 150 to 180 g, or of 180 to 200 g, or of 200 to 300 g.

The audio exciter advantageously has a diameter of 10 to 150 mm, for example, of 30 to 100 mm. Alternatively, the audio exciter can have a length of 30 to 200 mm, for example of 50 to 150 mm, and/or a width of 10 to 100 mm, for example of 20 to 60 mm. The audio exciter can have a depth of 10 to 50 mm, for example of 12 to 30 mm.

The audio exciter can be configured to generate high frequencies and/or medium frequencies and/or low frequencies. “High frequencies” is understood to mean sound waves with a frequency higher than 2000 Hz. “Medium frequencies” is understood to mean sound waves with a frequency ranging from 300 to 2000 Hz. “Low frequencies” is understood to mean sound waves with a frequency lower than 300 Hz. The audio exciter can comprise a signal filter for limiting the generated frequency band, e.g., to high and/or medium and/or low frequencies. For example, the signal filter can limit the emitted frequency band to a frequency range, this frequency range having a lower limit which is greater than or equal to 2000 Hz, or which is greater than or equal to 300 Hz, or which is greater than or equal to 150 Hz, or this frequency range having an upper limit that is less than or equal to 300 Hz.

The audio exciter can be placed at any point on the glass sheet or on the glazed assembly. In particular, it can be positioned in a peripheral zone of the glass sheet or of the glazed assembly. “Peripheral zone of the glass sheet” or “peripheral zone of the glazed assembly” are understood to mean a part of the glass sheet, or of the glazed assembly, respectively, adjacent to the edges of the glass sheet or of the glazed assembly, respectively (that is, to the edges delimiting the glass sheet or the glazed assembly). In certain embodiments, the peripheral zone of the glass sheet or of the glazed assembly is the zone of the glass sheet or of the glazed assembly adjacent to the edges of the glass sheet or of the glazed assembly and with a width (that is, in a direction orthogonal to the edge of the glass sheet or of the glazed assembly, in the plane of the glass sheet or of the glazed assembly) of less than or equal to 30 cm, or of less than or equal to 25 cm, or of less than or equal to 20 cm, or of less than or equal to 15 mm.

The glass sheet or the glazed assembly can comprise one or more openings for the passage of the power supply wires of the audio exciter, in addition to the at least one hole into which the mounting is inserted.

The audio exciter is mounted on a mounting, the mounting being inserted into the hole of the glass sheet or of the glazed assembly. The mounting can be totally inserted into the hole, or, preferably, only a part of the mounting is inserted into the hole.

The mounting can have any possible shape. Conveniently, the mounting is a prism or a cylinder. Thus, the mounting can have a cross section (according to a plane parallel to the main plane of the glass sheet or of the glazed assembly) which is circular or rectangular. It can be solid or hollow. The mounting has one or more side faces (when the mounting is hollow, these side faces denote the outer side faces of the mounting). The mounting can have a lower face.

Advantageously, the hole in the glass sheet or the glazed assembly and the mounting (and more particularly the part of the mounting inserted into said hole) have a substantially identical cross section (with the understanding that the cross section of the mounting is less than or can be made less than that of the hole, to allow the fitting of the mounting into the hole). Preferably, the part of the mounting inserted into the hole has a shape (in three dimensions) substantially identical to that of the hole.

The insertion of the mounting into the hole of the glass sheet or of the glazed assembly should be such as to allow vibrations to be transferred from the audio exciter to the glass sheet or to the glazed assembly. In other words, it should provide at least one point of contact (direct or indirect) between the mounting on which the audio exciter is mounted and the glass sheet or the glazed assembly. Preferably, at least one point of contact (direct or indirect) is present between the one or more side faces of the mounting and the one or more side inner surfaces of the hole. Conveniently, the mounting is secured in the hole by means of adhesive and/or by clamping of the mounting in the hole. In particular, the one or more side faces of the mounting can be bonded to the one or more side inner surfaces of the hole and/or the one or more side faces of the mounting can be clamped against the one or more side inner surfaces of the hole. Examples of adhesives that can be used for the invention are single- or multi-component structural adhesives, for example, such as epoxy, methacrylate, polyurethane, acrylic, vinyl, or a combination thereof.

In the embodiments wherein the mounting is secured by clamping, the mounting preferably comprises, when it is not inserted into the hole of the glass sheet or of the glazed assembly, at least one part having a cross section that is greater than the cross section of the hole. This part of the mounting has a flexibility or a deformability that make it possible, by applying a pressure, to reduce the cross section of said part until it is less than that of the hole, said part being configured to return to its initial shape once the pressure is no longer applied. Thus, when the mounting is inserted into the hole of the glass sheet or of the glazed assembly, the one or more side faces of the mounting are subject to stress by the side inner surfaces of the hole which keeps them in contact with the latter. Preferably, the mounting is hollow, more preferably, openings are present in the one or more side faces of the mounting. These openings make it possible to create a space in which the flexible/deformable part of the mounting can be moved when a pressure is applied.

When the hole in the glass sheet or the glazed assembly is a through-hole, the mounting can be secured in the hole by clamping by means of clips. An example of a mounting that can be used for such embodiments is shown in FIG. 12 (depicting the mounting before its insertion into the hole of the glass sheet or the glazed assembly and in FIG. 13 (depicting the mounting after its insertion into the hole of the glass sheet 1 (which can alternatively be a glazed assembly)). Referring to these figures, the mounting can comprise an upper part 3 and a lower part 4, which can be as disclosed below. The lower part 4 is preferably hollow and openings are preferably provided in its side face. It is flexible so that the dimensions of its cross section can be reduced, reversibly, by applying a pressure, as shown in FIG. 13 (the pressure being applied by the side inner surfaces of the hole in the glass sheet 1, or in the glazed assembly). The lower part 4 can comprise a prominent part 10, advantageously forming a clip. The prominent part 10 preferably comprises an upper face 11 intended for being in contact, directly or indirectly, with the main surface of the glass sheet or of the glazed assembly opposite the surface of the glass sheet or of the glazed assembly on the side of which the audio exciter is present.

When the hole in the glass sheet or the glazed assembly is blind, the lower face of the mounting preferably bears against the lower inner surface of the hole. In other words, the lower face of the mounting is in contact, direct or indirect, with the lower inner surface of the hole. The lower face of the mounting can be secured to the glass sheet or to the glazed assembly (on the lower inner surface of the hole), for example, by means of adhesive, in particular by an adhesive as disclosed herein before. This makes it possible to create a contact zone between the mounting and the additional glass sheet or glazed assembly in order to transmit the vibrations from the audio exciter to the glass sheet or to the glazed assembly.

Preferably, the mounting comprises a lower part and an upper part. More preferably, the upper part of the mounting projects with respect to the lower part of the mounting (preferably in a direction orthogonal to the main plane of the glass sheet or of the glazed assembly). In other words, the upper part projects beyond the lower part (preferably in a plane parallel to the main plane of the glass sheet or of the glazed assembly), preferably over the entire perimeter of the lower part of the mounting. Preferably the lower part of the mounting is inserted into the hole of the glass sheet or of the glazed assembly (partially or totally). It can be secured in the hole by bonding and/or by clamping, as disclosed herein before, in particular between the one or more side faces thereof and the one or more side inner surfaces of the hole.

The lower part of the mounting can have any suitable shape, such as a prism or cylinder. It can, for example have a cross section (according to a plane parallel to the main plane of the glass sheet or of the glazed assembly) that is circular or rectangular. More preferably, the hole in the glass sheet or the glazed assembly and the lower part of the mounting inserted into said hole have a substantially identical cross section. The lower part of the mounting can be solid or hollow.

The lower part of the mounting can have a lower face (which corresponds to the lower face of the mounting) and to one or more side faces. The lower face of the lower part of the mounting can bear against the lower inner surface of the hole when the hole is blind, as is disclosed herein before in relation to the lower face of the mounting.

The upper part of the mounting can have any shape and can particularly have a cross section (according to a plane parallel to the main plane of the glass sheet or of the glazed assembly) that is circular or rectangular. The upper part of the mounting can have a cross section with a diameter of 10 to 55 mm, for example, of 15 to 35 mm. In other embodiments, the upper part of the mounting can have a cross section with a length of 10 to 80 mm, for example, of 30 to 60 mm, and/or with a width of 10 to 80 mm, for example, of 30 to 60 mm. The upper part of the mounting can have a thickness of 1 to 10 mm, for example, of 2 to 6 mm.

Preferably, the lower part of the mounting is centered on the upper part of the mounting.

The upper part of the mounting comprises a lower face (corresponding to the lower surface of the part of the upper part of the mounting that projects with respect to the lower part of the mounting).

The lower face of the upper part of the mounting can partially cover the glass sheet or the glazed assembly, that is, the lower face of the upper part of the mounting is in contact, direct or indirect, with the glass sheet or the glazed assembly. The lower face of the upper part of the mounting can be secured to the glass sheet or to the glazed assembly, for example, by means of adhesive, in particular by an adhesive as disclosed herein before. This makes it possible to create a contact zone between the mounting and the additional glass sheet or glazed assembly in order to transmit the vibrations from the audio exciter to the glass sheet or to the glazed assembly.

Alternatively, the lower face of the upper part of the mounting cannot cover the glass sheet or the glazed assembly, that is, the lower face of the upper part of the mounting is not in contact with the glass sheet or the glazed assembly. This can, for example, be the case when the glass sheet or the glazed assembly is curved while the lower face of the upper part of the mounting is flat.

Embodiments of the invention are depicted in FIGS. 1 to 11. These embodiments show the invention without limiting it.

Referring to FIG. 1, in certain embodiments, the glazing comprises a glass sheet 1 comprising a through-hole. The glazing also comprises an audio exciter 2 mounted on a mounting comprising an upper part 3 and a lower part 4. The lower part 4 of the mounting is inserted into the hole of the glass sheet 1 and its side surface is coupled with the side inner surface of the hole, for example, by bonding or by clamping. Preferably, the lower part 4 of the mounting is inserted into the hole over the entire depth of the hole, and more preferably the lower face 5 of the lower part 4 of the mounting is coplanar or substantially coplanar with the lower main surface of the glass sheet 1 (which is the surface opposite the surface of the glass sheet 1 on the side of which the upper part 3 of the mounting and the audio exciter 2 are provided). The lower face 9 of the upper part 3 of the mounting is not in contact with the glass sheet 1.

Referring to FIG. 2, in certain embodiments, the glazing comprises a glass sheet 1 comprising a through-hole. The glazing also comprises an audio exciter 2 mounted on a mounting comprising an upper part 3 and a lower part 4. The lower part 4 of the mounting is inserted into the hole of the glass sheet 1 and its side surface is coupled with the side inner surface of the hole, for example, by bonding or by clamping. Preferably, the lower part 4 of the mounting is inserted into the hole over the entire depth of the hole, and more preferably the lower face 5 of the lower part 4 of the mounting is coplanar or substantially coplanar with the lower main surface of the glass sheet 1. The lower face 9 of the upper part 3 of the mounting is coupled with the upper surface of the glass sheet 1 (which is the surface of the glass sheet 1 on the side of which the upper part 3 of the mounting and the audio exciter 2 are provided), for example, by bonding.

Referring to FIG. 3, in certain embodiments, the glazing comprises a glass sheet 1 comprising a blind hole. The glazing also comprises an audio exciter 2 mounted on a mounting comprising an upper part 3 and a lower part 4. The lower part 4 of the mounting is inserted into the hole of the glass sheet 1, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is not in contact with the glass sheet 1.

Referring to FIG. 4, in certain embodiments, the glazing comprises a glass sheet 1 comprising a blind hole. The glazing also comprises an audio exciter 2 mounted on a mounting comprising an upper part 3 and a lower part 4. The lower part 4 of the mounting is inserted into the hole of the glass sheet 1, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is coupled with the upper surface of the glass sheet 1, for example, by bonding.

Referring to FIG. 5, in certain embodiments, the glazing comprises a glazed assembly 12 formed by laminated glazing comprising a first glass sheet (or upper glass sheet) 6, an interlayer film 7 and a second glass sheet (or lower glass sheet) 8. The glazed assembly 12 comprises a through-hole. The glazing also comprises an audio exciter 2 mounted on a mounting comprising an upper part 3 and a lower part 4. The lower part 4 of the mounting is inserted into the hole of the glazed assembly 12, over the entire depth of the hole, and its side surface is coupled with the side inner surface of the hole, for example, by bonding or by clamping. Preferably, the lower part 4 of the mounting is inserted into the hole over the entire depth of the hole, and more preferably the lower face 5 of the lower part 4 of the mounting is coplanar or substantially coplanar with the lower main surface of the glazed assembly 12 (which is the surface opposite the surface of the glazed assembly 12 on the side of which the upper part 3 of the mounting and the audio exciter 2 are provided). The lower face 9 of the upper part 3 of the mounting is not in contact with the glazed assembly 12.

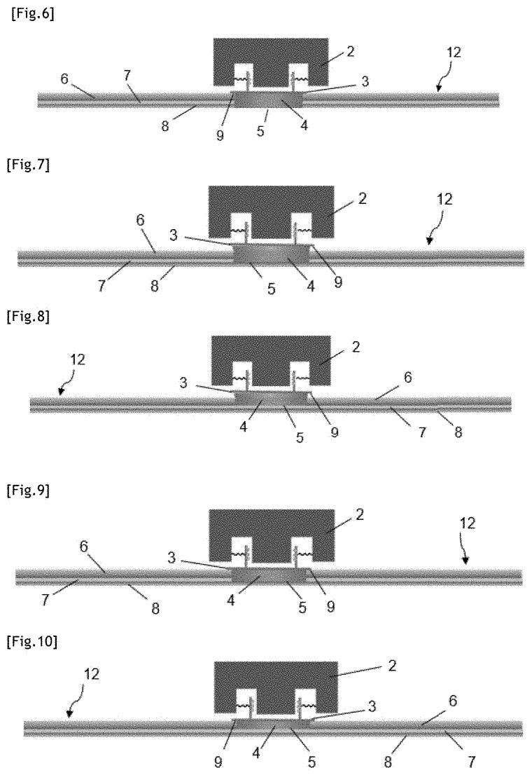

Referring to FIG. 6, in certain embodiments, the glazing comprises a glazed assembly 12 formed by laminated glazing comprising a first glass sheet 6, an interlayer film 7 and a second glass sheet 8. The glazed assembly 12 comprises a through-hole. The glazing also comprises an audio exciter 2 mounted on a mounting comprising an upper part 3 and a lower part 4. The lower part 4 of the mounting is inserted into the hole of the glazed assembly 12 and its side surface is coupled with the side inner surface of the hole, for example, by bonding or by clamping. Preferably, the lower part 4 of the mounting is inserted into the hole over the entire depth of the hole, and more preferably the lower face 5 of the lower part 4 of the mounting is coplanar or substantially coplanar with the lower main surface of the glazed assembly 12. The lower face 9 of the upper part 3 of the mounting is coupled with the upper surface of the glazed assembly 12 (which is the surface of the glazed assembly 12 on the side of which the upper part 3 of the mounting and the audio exciter 2 are present), for example, by bonding.

Referring to FIG. 7, in certain embodiments, the glazing comprises a glazed assembly 12 formed by laminated glazing comprising a first glass sheet 6, an interlayer film 7 and a second glass sheet 8. The glazed assembly 12 comprises a blind hole extending through the first glass sheet 6 and the interlayer film 7, until the upper surface of the second glass sheet 8. The glazing also comprises an audio exciter 2 mounted on a mounting comprising an upper part 3 and a lower part 4. The lower part 4 of the mounting is inserted into the hole of the glazed assembly 12, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is not in contact with the glazed assembly 12.

Referring to FIG. 8, in certain embodiments, the glazing comprises a glazed assembly 12 formed by laminated glazing comprising a first glass sheet 6, an interlayer film 7 and a second glass sheet 8. The glazed assembly 12 comprises a blind hole extending through the first glass sheet 6, until the upper surface of the interlayer film 7. The glazing also comprises an audio exciter 2 mounted on a mounting comprising an upper part 3 and a lower part 4. The lower part 4 of the mounting is inserted into the hole of the glazed assembly 12, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is not in contact with the glazed assembly 12.

Referring to FIG. 9, in certain embodiments, the glazing comprises a glazed assembly 12 formed by laminated glazing comprising a first glass sheet 6, an interlayer film 7 and a second glass sheet 8. The glazed assembly 12 comprises a blind hole extending through the first glass sheet 6 and the interlayer film 7, until the upper surface of the second glass sheet 8. The glazing also comprises an audio exciter 2 mounted on a mounting comprising an upper part 3 and a lower part 4. The lower part 4 of the mounting is inserted into the hole of the glazed assembly 12, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is coupled with the upper surface of the glazed assembly 12, for example, by bonding.

Referring to FIG. 10, in certain embodiments, the glazing comprises a glazed assembly 12 formed by laminated glazing comprising a first glass sheet 6, an interlayer film 7 and a second glass sheet 8. The glazed assembly 12 comprises a blind hole extending through the first glass sheet 6, until the upper surface of the interlayer film 7. The glazing also comprises an audio exciter 2 mounted on a mounting comprising an upper part 3 and a lower part 4. The lower part 4 of the mounting is inserted into the hole of the glazed assembly 12, over the entire depth of the hole, and its side surface is coupled with the side inner surface of the hole, for example, by bonding or by clamping. The lower face 5 of the lower part 4 of the mounting is coupled with the lower inner surface of the hole, for example, by bonding. The lower face 9 of the upper part 3 of the mounting is coupled with the upper surface of the glazed assembly 12, for example, by bonding.

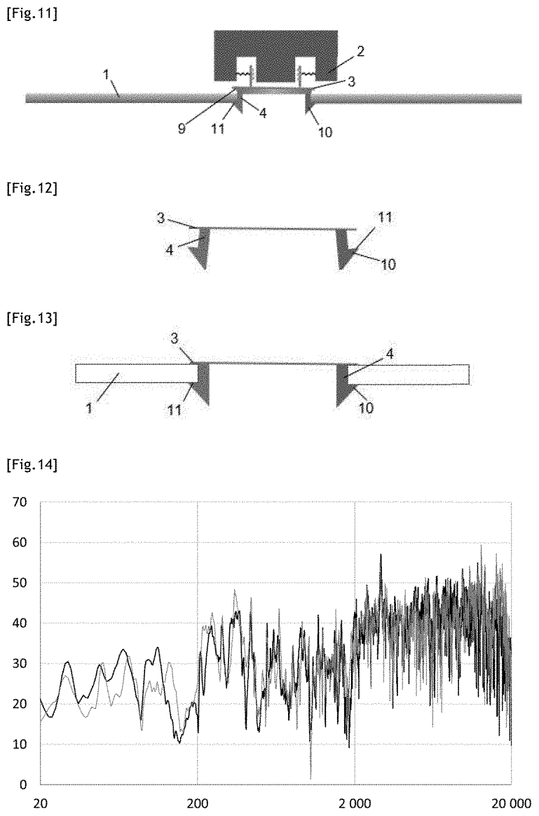

Referring to FIG. 11, in certain embodiments, the glazing comprises a glass sheet 1 comprising a through-hole. The glazing also comprises an audio exciter 2 mounted on a mounting comprising an upper part 3 and a lower part 4. The lower part 4 of the mounting is inserted into the hole of the glass sheet 1 and its side surface is coupled with the side inner surface of the hole by clamping. The lower part 4 comprises a prominent part 10 which comprises an upper face 11 on which the glass sheet 1 bears (by its lower main surface). The lower face 9 of the upper part 3 of the mounting is not in contact with the glass sheet 1. In other embodiments, the lower face 9 of the upper part 3 of the mounting can be in contact with the upper surface of the glass sheet 1. In further embodiments, the glazing can comprise, instead of the glass sheet 1, a glazed assembly, for example, formed by a laminated glazing.

The audio exciter can be mounted on the mounting in a fixed or removable fashion. In particular, the mounting can comprise an attachment part on which the audio exciter is secured, preferably in a removable manner. This has the advantage that the exciter can be easily removed and changed, for example, in the event of a malfunction. The audio exciter can be secured to the attachment part of the mounting by screwing. In particular, the attachment part can comprise or consist of one or more threaded parts (or rods) projecting from the mounting (these threaded parts having a main axis preferably oriented in a direction orthogonal to the main plane of the glass sheet or of the glazed assembly). In these embodiments, the audio exciter comprises one or more tapped holes capable of being screwed onto the one or more threaded parts of the mounting. Alternatively, or additionally, the attachment part can comprise or consist of one or more tapped holes provided in the mounting (these tapped holes having a main axis preferably oriented in a direction orthogonal to the main plane of the glass sheet or of the glazed assembly). In these embodiments, the audio exciter comprises one or more threaded parts capable of being screwed into the one or more tapped holes of the mounting. Alternatively, or additionally, to a mode for securing by screwing, the audio exciter can be secured to the attachment part of the mounting by interlocking. In these embodiments, the attachment part of the mounting and the audio exciter each comprise one or more indentations configured to interlock with each other. For example, the attachment part can be a part of the mounting comprising at least one notch (for example, rectangular), preferably at least two notches, on its one or more side faces, or a part of the mounting comprising at least one clip, preferably at least two clips, on the one or more side faces thereof, or a part of the mounting comprising at least one notch, which can be of any suitable shape, on its upper face.

Advantageously, the mounting comprises or is made of metal material, thermoplastic material or a combination thereof. Examples of metal materials suited to the mounting according to the invention are aluminum and/or stainless steel. Examples of thermoplastic materials include the polyphthalamides, such as those sold under the trademark Grivory®, polyvinyl chloride (PVC) and/or polyethylene terephthalate (PET). Preferably, the mounting does not comprise magnetic material, in particular if the audio exciter is an electrodynamic exciter, so as not to interfere with the magnetic circuit of the exciter.

In particular, the possible lower part of the mounting, upper part of the mounting and attachment part can independently comprise or be made of the above-mentioned materials.

### Manufacturing Method

The invention also relates to a method for manufacturing a glazing as disclosed herein before.

According to a first variant, the manufacturing method can comprise:
providing a glass sheet or a glazed assembly and at least one audio exciter mounted on a mounting;
boring at least one hole in the glass sheet or the glazed assembly; and
inserting the mounting into the at least one hole of the glass sheet or of the glazed assembly.

The boring of the hole in the glass sheet or in the glazed assembly can be carried out by means of a drill, a milling cutter, a diamond bit or a high-pressure water jet.

Prior to its insertion into the hole, adhesive can be deposited on the mounting, in particular on the one or more side surfaces thereof. Alternatively or additionally, adhesive can be deposited on the one or more side inner surfaces of the hole.

When the hole is blind and the lower face of the mounting is intended for resting on the lower inner surface of the hole, adhesive can be deposited on the lower face of the mounting. Alternatively or additionally, adhesive can be deposited on the lower inner surface of the hole.

When the mounting comprises an upper part, intended for covering the glass sheet or the glazed assembly, adhesive can be deposited on the lower face of the upper part of the mounting. Alternatively or additionally, adhesive can be deposited on the surface of the glass sheet or of the glazed assembly intended for being covered by the upper part of the mounting.

The potential gluing of the mounting, its positioning and its insertion into the hole of the glass sheet or of the glazed assembly can be carried out independently by industrial production line means that are well known for a skilled person, such as robotized machines, or by manual means. In certain embodiments, the mounting can be inserted into the hole so as to be clamped in the hole. For example, a pressure can be applied to a flexible or deformable part of the mounting so as to reduce its external dimensions before inserting the mounting into the hole of the glass sheet or of the glazed assembly.

According to a second variant, the manufacturing method can comprise:
providing a glass sheet or a glazed assembly, at least one audio exciter and at least one mounting;
boring at least one hole in the glass sheet or the glazed assembly;
inserting the at least one mounting into the at least one hole of the glass sheet or of the glazed assembly; and
mounting the at least one audio exciter on the at least one mounting.

The boring of the glass sheet or of the glazed assembly, the possible bonding of the mounting and the insertion of the mounting into the hole can be as disclosed herein before in relation with the first alternative method.

In this variant, the mounting comprises an attachment part intended for receiving the audio exciter. The audio exciter can be mounted on the mounting by screwing and/or interlocking the audio exciter onto the attachment part.

### Uses

The glazing according to the invention can be used in any application that uses glazings.

In particular, the glazing according to the invention can be a vehicle glazing. The vehicle can be any type of vehicle comprising at least one glazing. Preferably, this is a land transport motor vehicle, although the present invention is also applicable to glazings for aeronautical vehicles, such as helicopters, airplanes and ships. More preferentially, the vehicle is a motor vehicle (car). Alternatively, the vehicle can be a truck, van, bus or coach.

The glazing according to the invention can be any vehicle glazing. In particular, it can be a windscreen, any side glazing, in particular door glazing, a rear window and/or roof glazing.

When the glazing is intended to be oriented vertically or substantially vertically in the vehicle (in particular when it is intended to be a windscreen, side glazing or a rear window), the exciter is advantageously located in a peripheral zone of the glass sheet or of the glazed assembly adjacent to the lower edge of the glass sheet or of the glazed assembly (that is, the edge intended for being on the side of the bottom of the vehicle).

When the glazing is a windscreen, the audio exciter can, additionally or alternatively, be located on a peripheral zone of the glass sheet or of the glazed assembly adjacent to the upper edge of the glass sheet or of the glazed assembly (that is, the edge intended for being on the side of the top of the vehicle), preferably in a central zone of this upper peripheral zone (for example, in a zone of the upper peripheral zone extending over a length of 30 cm, preferably 20 cm, in a direction parallel to the upper edge of the windscreen, on either side of the center of the upper edge). More preferably, when the windscreen comprises or is intended to comprise an interior rear-view mirror, the audio exciter is placed near the interior rear-view mirror fasteners of the windscreen (for example, in a circular zone of the windscreen with a radius of less than or equal to 15 cm of which the center consists of the fasteners of the interior rear-view mirror or the location intended for receiving the fasteners of the rear-view mirror).

The invention can be intended for equipping a vehicle, preferably a motor vehicle. In these embodiments, the at least one audio exciter is intended for being located in the passenger compartment of the vehicle. In other words, it is intended for being placed on the inner surface of the glass sheet or of the glazed assembly.

The audio exciter can be intended for being covered or surrounded by a vehicle interior trim, so as to be entirely or partially concealed from the passengers of the vehicle.

Preferably, a vehicle can comprise at least two audio exciters. For example, the vehicle can comprise a glazing unit according to the invention comprising at least two audio exciters, can comprise at least two glazing units according to the invention each comprising at least one audio exciter, or can comprise at least one glazing unit according to the invention comprising at least one audio exciter and at least one other audio exciter, located in a glazing unit of the vehicle or in any other location of the vehicle (such as in a pillar, in a door, in the dashboard, or in the roof).

The glazing according to the invention can alternatively be a construction glazing. The glazing can be intended to serve as an interface between the outside and the inside of the building and can be for example a window or facade glazing. Alternatively, the glazing can be intended to be placed inside the building.

### EXAMPLE

The following example shows the invention in a non-limiting manner.

### Example 1

Two motor vehicle side glazings comprising a glass sheet of tempered glass with a thickness of 3.5 mm and an electrodynamic audio exciter with a nominal power of 30 W, a diameter of 46 mm and a weight of 130 g, were manufactured.

The glazing 1 is a glazing according to the invention. A mounting comprising a lower part and an upper part was manufactured by 3D printing. The lower part of the mounting was inserted into a through-hole, bored in the glass sheet, and bonded by means of an epoxy adhesive. The lower face of the upper part of the mounting does not cover the glass sheet, that is, the lower face of the upper part of the mounting is not in contact with the glass sheet.

The glazing 2 is a comparative glazing. In this glazing, the standard mounting of the exciter, provided with a double-sided adhesive tape, was used. The lower part of the mounting was secured to the glass sheet by means of the double-sided adhesive tape placed between the lower surface of the lower part of the mounting and the glass sheet.

The acoustic responses of the two glazings were measured for 1 W at 1 m by a class 1 measurement microphone.

The results are shown in FIG. 14.

It is noted that the glazing 1 according to the invention provides an acoustic response similar to that of the glazing 2 wherein the mounting of the exciter is secured by a double-sided adhesive tape onto the glass sheet. The invention thus provides an effective solution for integrating an audio exciter in a glazing.

1. A glazing comprising:
a glass sheet or a glazed assembly comprising at least one hole, the glazed assembly being a multilayer glazed element of which at least one layer is a glass sheet, and
at least one audio exciter mounted on a mounting;
wherein the mounting is inserted into the at least one hole of the glass sheet or of the glazed assembly.

2. The glazing according to claim 1, wherein the glass sheet is made of organic or mineral glass or the glazed assembly comprises at least one glass sheet which is made of organic or mineral glass and which comprises the hole.

3. The glazing according to claim 1, comprising said glazed assembly and wherein the glazed assembly is a laminated glazing comprising at least one first glass sheet and a second glass sheet between which at least one interlayer film made of viscoelastic plastic material is inserted, the interlayer film made of viscoelastic plastic material.

4. The glazing according to claim 3, wherein the at least one hole is only present in the first glass sheet or only present in the first glass sheet and in the at least one interlayer film made of viscoelastic plastic material.

5. The glazing according to claim 1, wherein the at least one hole is a blind hole.

6. The glazing according to claim 5, wherein the mounting comprises a lower face and the at least one hole comprises a lower inner surface, the lower face of the mounting bearing against the lower inner surface of the at least one hole.

7. The glazing according to claim 1, wherein the at least one hole is a through-hole.

8. The glazing according to claim 1, wherein the at least one hole and the mounting inserted into the at least one hole have a substantially identical cross section.

9. The glazing according to claim 1, wherein the mounting comprises a lower part and an upper part, the upper part projecting with respect to the lower part.

10. The glazing according to claim 9, wherein the upper part of the mounting has a lower face, said lower face partially covering the glass sheet or the glazed assembly.

11. The glazing according to claim 1, wherein the mounting is secured in the at least one hole by means of adhesive and/or by clamping of the mounting in the at least one hole.

12. The glazing according to claim 1, wherein the mounting comprises an attachment part, the audio exciter being secured to said attachment part.

13. The glazing according to claim 1, being a vehicle glazing.

14. The glazing according to claim 1, being a construction glazing.

15. A method for manufacturing a glazing according to claim 1, comprising:
providing a glass sheet or a glazed assembly and at least one audio exciter mounted on a mounting;
boring at least one hole in the glass sheet or the glazed assembly, and
inserting the mounting into the at least one hole of the glass sheet or of the glazed assembly.

16. A method for manufacturing a glazing according to claim 1, comprising:
providing a glass sheet or a glazed assembly, at least one audio exciter and at least one mounting;
boring at least one hole in the glass sheet or the glazed assembly;
inserting the at least one mounting into the at least one hole of the glass sheet or of the glazed assembly, and
mounting the at least one audio exciter onto the at least one mounting.

17. The glazing according to claim 3, wherein the viscoelastic plastic material is polyvinyl butyral (PVB), ethylene vinyl acetate copolymer or acoustic PVB.

18. The glazing according to claim 13, wherein the vehicle glazing is a glazing of a motor vehicle.

19. The glazing according to claim 14, wherein the constructions glazing is a glazing of a window or a building facade.
